(19) United States
(12) Patent Application Publication
(10) Pub. No.: US 2007/0281224 A1
(43) Pub. Date: Dec. 6, 2007

(54) SCRATCH-OFF DOCUMENT AND METHOD FOR PRODUCING SAME

(76) Inventors: Kerry Arthur Kirk, Farmington, NY (US); Alvin Daniel Kromm, Webster, NY (US); Paul Marcius Butterfield, Ontario, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/421,251

(22) Filed: May 31, 2006

(51) Int. Cl. G03G 15/08; G03C 3/00

(52) U.S. Cl. 430/18; 430/126.1

(57) ABSTRACT

A scratch-off document and a method for producing a scratch off document are disclosed. The scratch-off document may include: a base material; a first toner layer affixed to the base material, wherein the first toner layer comprises a content to be masked; an optional barrier layer; and a second toner layer removably affixed to the barrier layer, so that the second toner layer may be removed when scratched using a hard object.

### CROSS-REFERENCE TO RELATED APPLICATIONS

Not Applicable.

### STATEMENT REGARDING FEDERAL SPONSORED RESEARCH

Not Applicable.

### JOINT RESEARCH AGREEMENT

Not Applicable.

### INCORPORATION BY REFERENCE OF MATERIAL ON DISC

Not Applicable.

### BACKGROUND

“Scratch-off” type documents are used in many applications. For example instant lottery tickets are printed with data that is covered by a scratch-off material. When the scratch-off material is removed by rubbing with a coin, fingernail, or other object, the data under the scratch-off coating is revealed. In addition to lotteries, other such documents are often used for other games, such as retail store contests or product giveaways.

The scratch-off material in a scratch-off document must adhere to the base material sufficiently so that it does not rub off in ordinary handling, but so that it is easy to rub off with a scratching object such as a coin or fingernail. Scratch-off documents are traditionally produced using a preprinted document in which a wax-like coating or film is applied over the data that is desired to be hidden. The application of wax-like coatings require the use of additional or specialized hardware, thus increasing the associated costs and maintenance associated with producing the scratch-off ticket.

Accordingly, what is needed is an improved scratch-off document and method for creating a scratch-off document.

### SUMMARY

A scratch-off document, and a method for making such document, is taught and claimed. The scratch-off document may be used for example, but not limited to, lottery tickets, other games of chance, retail store contests, and product giveaways. One embodiment of the scratch-off document may comprise a base material, and a first toner layer affixed to the base material. The first toner layer may have content that is to be masked. The first toner layer may be fused to the base material. The concept of fusing is well known in the art of xerography. The embodiment may further comprise an optional barrier layer, and a second toner layer that is removably affixed to the barrier layer or the first layer, so that the second toner layer may be removed when scratched using a hard object. The content to be masked of the first toner layer may comprise an image, or a phrase, or some indication relating to a game of chance.

In another embodiment, the document may include a base material, and an image preprinted on the base material. The image may be preprinted on the base material using, for example, but not limited to, an offset printing method, including lithography; a xerographic process; relief printing; screen printing; intaglio printing; digital-based ink jet printing; high-speed ink jet printing, and laser printing. Any method of printing now or hereafter known to those skilled in the art is within the scope of the embodiments herein. The preprinted image may have a content to be masked. The preprinted image may be fused according to any fusing process that is now or hereafter known to those of ordinary skill in the art. The preprinted image may optionally be covered with a barrier layer, and then covered once again with a removably affixed toner layer. In another embodiment, the content to be masked of the preprinted image is directly covered with a removably affixed toner.

### BRIEF DESCRIPTION OF THE DRAWINGS

FIG. 1 depicts a cross-section of an exemplary scratch-off document of an embodiment showing first and second toner layers.

FIG. 2A-2C depicts stages of a scratch-off document using first and second toner layers.

FIG. 3 depicts a cross-section of an embodiment of an exemplary scratch-off document which comprises a base material with a preprinted image.

FIG. 4A and 4B depicts stages of a scratch-off document using a preprinted base material.

FIG. 5 depicts a flow diagram of an embodiment of a method of making a scratch-off document.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

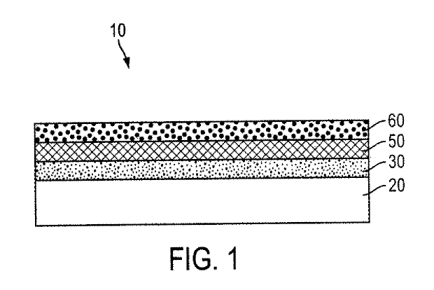

In accordance with one embodiment, as illustrated in FIG. 1, an exemplary scratch-off document 10 includes a base material 20, such as, but not limited to, paper, card stock, or other material. The base material 20 may be coated using a xerographic process with a first toner layer 30. In an embodiment, the first toner layer 30 may comprise an image, graphic, or other visual indication. The first toner layer 30 may cover the entire base material 20 or portions thereof. The first toner layer 30 may be fused to the base material. Fusing may be used to melt the toner into the base material, so that it is not easily removed, and it is essentially permanently affixed to the base material. Fusing methods may include hot roll fusing, cold roll fusing, radiant fusing, solvent fusing, or any method of fusing that is now or hereafter known to one skilled in the art of xerography.

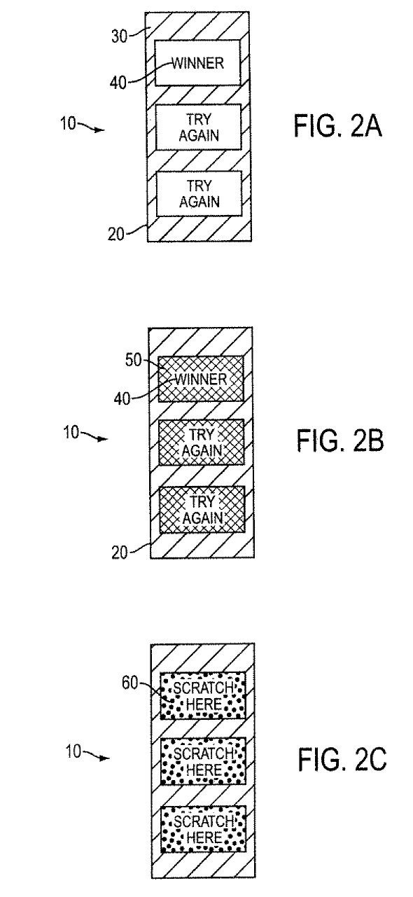

Referring to FIG. 2A, the first toner layer 30 may further comprise content to be masked 40. The content to be masked 40 may include graphics, text or other indication associated with lottery tickets, other games of chance, retail store contests, product giveaways, and any other matters that may be the subject of the scratch-off document 10.

Referring to FIGS. 1 and 2B, the first toner layer 30 may be covered with an optional barrier layer 50. The optional barrier layer 50 is a composition that prevents a second toner layer 60 from fusing with the first toner layer 30 that is affixed to the base material 20. The optional barrier layer 50 may be fused to the first toner layer 30, utilizing fusing methods that are now or hereafter known to those skilled in the art. The optional barrier layer 50 may be clear, transparent or nearly transparent. In an embodiment, the optional barrier layer 50 may comprise an ultraviolet cured polymeric coating, otherwise known to those of ordinary skill in the art as an ultraviolet coating, a UV coating, a UV clear coating, or a UV clear coat. Alternatively, the optional barrier layer 50 may comprise any coating that is clear or nearly clear, is compatible with toner layers and other inks, and prevents a second toner layer 60 from fusing with a first toner layer 30 that is affixed to the base material 20.

In one embodiment, the barrier layer 50 may comprise an epoxy-acrylate UV coating such as, but not limited to, Ultracoat UV X2 Gloss Coating from Fuji Hunt Photographic Chemicals, Inc. In an alternative embodiment, the optional barrier layer may be a solvent-based clear coating, such as, but not limited to ClearJet® from ClearStar Coatings Corps.

The optional barrier layer 50 may cover the entire base material 20. Alternatively, the optional barrier layer 50 may only cover one or more portions of the document 10. However, the optional barrier layer 50 may, at a minimum, cover the contents to be masked 40 portions of the first toner layer 30. The optional barrier layer 50 may be clear, transparent, or nearly transparent, so that content to be masked 40 is visible through the optional barrier layer 50.

Referring to FIGS. 1 and 2C, a second toner layer 60 then covers all or a portion of the barrier layer 50 so that the second toner layer 60, at minimum, covers and masks the content to be masked 40. In a further embodiment, the second toner layer 60 may be fused so that during handling the second toner layer 60 is not removed or smudged, but is able to be scratched off using a hard object, such as a coin.

In an embodiment, the color or pattern of the second toner layer 60 is effective in masking the content to be masked 40. In an embodiment the second toner layer 60 may be of a dark color or similar to that of the first toner layer 30 on the base material 20 to provide effective masking. Dark color as used herein refers to a color having low lightness and low saturation, and reflecting only a small fraction of incident light, for example, but not limited to, black, brown, grey, and so forth. It is recognized that the exact color of the second toner layer 60 is not critical for the practice of the embodiments herein; the second toner layer 60 need only be effective in masking the contents to be masked. Alternatively, or in addition, the second toner layer 60 could be patterned with, for example, but not limited to, stripes, checks, and so forth, to provide further masking.

The second toner layer 60 does not come off of the optional barrier layer 50 in ordinary short term handling. However, the second toner layer 60 is easily removed from the optional barrier layer 50 when scratched with a coin, fingernail or other hard object. When the second toner layer 60 is scratched off, the contents to be masked 40 are revealed providing some indication to the user of the scratch-off document 10 of their standing or result regarding the lottery tickets, other games of chance, retail store contests, product giveaways, and any other matters that may be the subject of scratch-off documents 10.

In an embodiment, the first toner layer 30 and the second toner layer 60 may comprise iGen3® Digital Production Press—Bulk Toner from the Xerox® Corporation. The first and second toner layers (30, 60) may alternatively include any other toner material familiar to those of ordinary skill in the art.

Toner compositions are known, such as those disclosed in U.S. Pat. No. 4,543,313, the disclosure of which is totally incorporated herein by reference. In U.S. Pat. No. 4,891,293, the disclosure of which is totally incorporated herein by reference, there are disclosed toner compositions with thermotropic liquid crystalline copolymers, and wherein sharp melting toners are illustrated. Moreover, in U.S. Pat. No. 4,973,539, the disclosure of which is totally incorporated herein by reference, there are disclosed toner compositions with crosslinked thermotropic liquid crystalline polymers.

Low fixing toners comprised of semicrystalline resins are also known, such as those disclosed in U.S. Pat. No. 5,166,026, the disclosure of which is totally incorporated herein by reference, and wherein toners comprised of a semicrystalline copolymer resin, such as poly(alpha-olefin) copolymer resins, with a melting point of from about 30° C. to about 100° C., and containing functional groups comprising hydroxy, carboxy, amino, amido, ammonium or halo, and pigment particles, are disclosed. Similarly, in U.S. Pat. No. 4,952,477, the disclosure of which is totally incorporated herein by reference, toner compositions comprised of resin particles selected from the group consisting of semicrystalline polyolefin and copolymers thereof with a melting point of from about 50° C. to about 100° C., and containing functional groups comprising hydroxy, carboxy, amino, amido, ammonium or halo, and pigment particles, are disclosed. Similarly, in U.S. Pat. No. 4,952,477, the disclosure of which is totally incorporated herein by reference, toner compositions comprised of resin particles selected from the group consisting of semicrystalline polyolefin and copolymers thereof with a melting point of from about 50° C. to about 100° C. and pigment particles are disclosed. In U.S. Pat. No. 4,990,424, the disclosure of which is totally incorporated herein by reference, toners including a blend of resin particles containing styrene polymers or polyesters, and components selected from the group consisting of semicrystalline polyolefin and copolymers thereof with a melting point of from about 50° C. to about 100° C. are disclosed. Fusing temperatures of from about 250° F. to about 330° F. (degrees Fahrenheit) are reported.

Low fixing crystalline based toners are disclosed in U.S. Pat. No. 6,413,691, the disclosure of which is totally incorporated herein by reference, and wherein a toner including a binder resin and a colorant, the binder resin containing a crystalline polyester containing a carboxylic acid of two or more valences having a sulfonic acid group as a monomer component, is illustrated. The crystalline resins of the '691 patent are believed to be opaque, resulting in low projection efficiency.

Crystalline based toners are disclosed in U.S. Pat. No. 4,254,207, the disclosure of which is totally incorporated herein by reference. Low fixing toners comprised of crosslinked crystalline resin and amorphous polyester resin are illustrated in U.S. Pat. No. 5,147,747 and U.S. Pat. No. 5,057,392, the disclosures of which are totally incorporated herein by reference, and wherein the toner powder is comprised, for example, of polymer particles of partially carboxylated crystalline polyester and partially carboxylated amorphous polyester that has been crosslinked together at elevated temperature with the aid of an epoxy novolac resin and a crosslinking catalyst.

Also of interest are U.S. Pat. Nos. 6,383,205; 6,017,671; and 4,385,107, the disclosures of which are totally incorporated herein by reference. U.S. Patent Pub. No. 2004/0142266, herein incorporated by reference in its entirety, describes a toner comprised of a branched amorphous sulfonated polyester resin, a crystalline sulfonated polyester resin, a colorant and an optional wax. In the toner of the '266 Publication, the crystalline resin displays or possesses a melting temperature of from about 50° C. to about 110° C.; the amorphous branched resin has an average molecular weight of about 2,000 to about 300,000 grams per mole; and the crystalline resin displays an average molecular weight of about 1,000 to about 50,000 grams per mole.

U.S. Pat. No. 6,500,594, herein incorporated by reference in its entirety, describes an electrophotographic developer comprising a toner and a carrier, wherein the toner contains a colorant and a crystalline resin, and wherein the carrier has a nitrogen-containing resin coating. The toner of the '594 Patent preferably has specific rheological properties including certain dynamic viscosity characteristics. The toner has a storage elastic modulus (G′) of 1×10⁶ Pa or more and a loss elastic modulus (G″) of 1×10⁶ Pa or more at the angular frequency of 1 rad/sec and at 30° C. The elastic properties are related to toner hardness, stability, and fusing temperature. U.S. Pat. Nos. 6,582,896 and 6,607,864, herein incorporated by reference in their entirety, also describe toners having similar rheological characteristics.

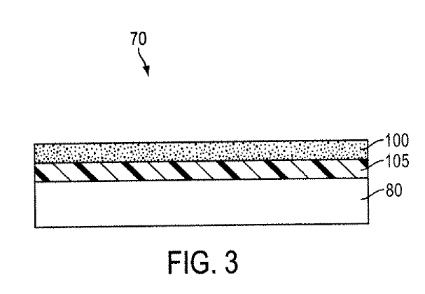

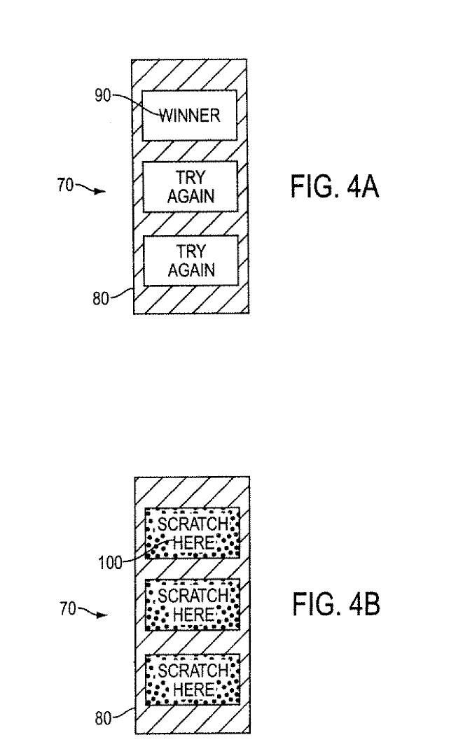

In another embodiment, in accordance with FIG. 3 and FIGS. 4A and 4B, an exemplary scratch-off document 70 includes a base material 80 with a preprinted content to be masked 90. The preprinted content to be masked 90 may result from a xerographic process. Alternatively, the preprinted content to be masked 90 may result from an offset printing process that may include, but is not limited to, a lithographic process. Alternatively, the preprinted content to be masked 90 may result from relief printing, screen printing, intaglio printing, digital-based ink jet printing, high-speed ink jet printing, and laser printing. The preprinted content to be masked 90 may be the product of any printing process that is now or hereafter known to those of ordinary skill in the art; all preprinted images, graphics, texts and other contents to be masked 90, no matter how produced are intended to be encompassed in the scope of the embodiments herein. The preprinted content to be masked may be fused by hot roll fusing, cold roll fusing, radiant fusing, solvent fusing, or any process of fusing known to those skilled in the art.

A toner layer 100 is removably affixed to the base material 80, so that the toner layer 100 may be removed when scratched using a hard object. The toner layer 100 may be fused so that it is not removed or smudged during handling, but may be removed when scratched using a hard object. The toner layer 100, at minimum, may cover the preprinted content to be masked 90. In an embodiment, the toner layer 100 has a color or pattern that effectively masks the preprinted content to be masked 90.

The preprinted content to be masked 90 may be formed of inks or other materials that provide both sufficient image quality and toner layer 100 adhesion. The adhesion of the toner layer 100 must be such that the toner layer 100 is not removed by normal handling, but can be scratched off using a hard object. Inks and other materials that are suitable for the preprinted content to be masked 90 include, but are not limited to, inks and toners described herein, and any ink, toner, or other material now or hereafter known to those skilled in the art. Such masking may apply to any of the embodiments described herein.

In a further embodiment of a scratch-off document 70, and continuing to refer to FIG. 3 and FIGS. 4A and 4B, the base material 80 with the preprinted content to be masked 90 may be optionally coated with a barrier layer 105, followed by application of the toner layer 100. The optional barrier layer 105 is a composition that prevents the toner layer 100 from fusing with the preprinted content to be masked 90 of the base material 80. The optional barrier layer 105 may be fused by processes now or hereafter known to those skilled in the art.

The optional barrier layer 105 may be clear, transparent, or nearly transparent. The optional barrier layer 105 may comprise an ultraviolet cured polymeric coating, otherwise known to those of ordinary skill in the art as an ultraviolet coating, a UV coating, a UV clear coating, or a UV clear coat. Alternatively, the optional barrier layer 105 may comprise any coating that is clear or nearly clear, is compatible with toners and inks, and prevents a toner layer 100 from fusing with the preprinted content to be masked 90 that is affixed to the base material 80.

In one embodiment, the optional barrier layer 105 may comprise an epoxy-acrylate UV coating such as, but not limited to, Ultracoat UV X2 Gloss Coating from Fuji Hunt Photographic Chemicals, Inc. In an alternative embodiment, the optional barrier layer 105 may be a solvent-based clear coating, such as, but not limited to ClearJet® from ClearStar Coatings Corps.

The optional barrier layer 105 may cover the entire base material 80. Alternatively, the optional barrier layer 105 may only cover one or more portions of the document 70. However, the optional barrier layer 105 may, at a minimum, cover the preprinted contents to be masked 90 portions of the base material 80. The optional barrier layer 105 may be clear, transparent, or nearly transparent, so that the preprinted content to be masked 90 is visible through the optional barrier layer 105.

In an embodiment, a toner layer 100 is removably affixed to the optional barrier layer 105, so that the toner layer 100 may be removed when scratched using a hard object. The toner layer 100 may be fused so that it is not removed or smudged during normal handling, but may be removed when scratched using a hard object.

In another embodiment, the toner layer 100 is removably affixed directly to the preprinted contents to be masked 90 portions of the base material 80. The toner layer 100, at minimum, may cover the preprinted content to be masked 90. In one embodiment, the toner layer 100 covers the optional barrier layer 105, which only covers the preprinted content to be masked 90. In an embodiment, the toner layer 100 has a color or pattern that effectively masks the preprinted content to be masked 90.

The toner layer 100 may comprise iGen3® Digital Production Press—Bulk Toner from the Xerox® Corporation. The toner layer 100 may comprise any toner know to those skilled in the art.

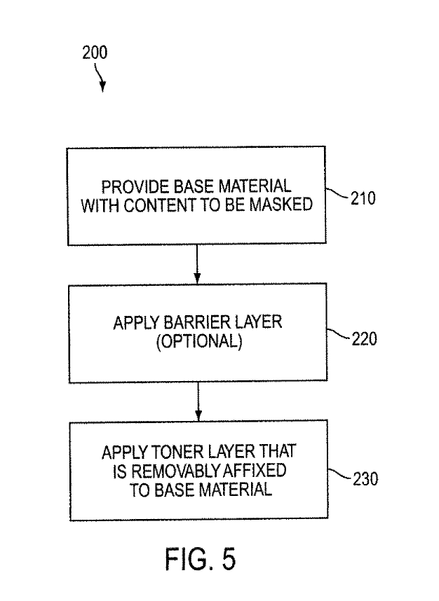

Now referring to FIG. 5, a method for producing a scratch-off document 200 is presented. The method 200 includes providing a base material with content to be masked 210. The base material 210 may include, but is not limited to, paper, card stock, or other material. The content to be masked provided on the base material 210 may comprise an image, graphic, or other visual indication, and may be applied by any printing process now or hereafter known to those of ordinary skill in the art. Such printing processes include, but are not limited to a xerographic process; an offset printing process, including lithography; relief printing; screen printing; intaglio printing; digital-based ink jet printing; and laser printing. The content to be masked on the base material 210 may be fused by hot roll fusing, cold roll fusing, radiant fusing, solvent fusing, or any fusing process now or hereafter known to those skilled in the art.

In an embodiment of a method for producing a scratch-off document 200, a barrier layer is optionally applied 220 over the base material with content to be masked 210. This optional step 220 may be useful in an embodiment in which the content to be masked 210 was produced using a xerographic process. The barrier layer may be fused using a fusing process now or hereafter known to those skilled in the art.

Continuing to refer to FIG. 5, a method for producing a scratch-off document includes applying a toner layer that is removably affixed to the base material 230. Application of the toner layer 230 should ensure that the toner layer is not removed during simple handling, but is removable when scratched with a fingernail, coin or other hard object. The toner layer 230 may be fused so that it is not removed or smudged during simple handling, but is removable when scratched with a fingernail, coin or other hard object.

When the optional step of applying a barrier layer 220 is used, application of the toner layer 230 proceeds over the optional barrier layer. The optional barrier layers may be applied 220 over the entire base material, or at minimum over the content to be masked on the provided base material 210. The optional barrier layer 220 may he fused so that it is permanently affixed to the content to be masked on the provided base material 210.

The optional barrier layer applied in 220 may comprise an ultraviolet cured polymeric coating, otherwise known to those of ordinary skill in the art as an ultraviolet coating, or simply a UV coating. In an embodiment the optional barrier layer applied in 220 is transparent, clear, or nearly clear so that the content to be masked provided with the base material 210 is readily identified through the optional barrier layer coating applied in 220. In one embodiment, the optional barrier layer may comprise a UV coating, such as, but not limited to Ultracoat UV X2 Gloss Coating from Fuji Hunt Photographic Chemicals, Inc.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A scratch-off document comprising:
a base material;
a first toner layer affixed to the base material, wherein the first toner layer comprises a content to be masked; and
a second toner layer over the first toner layer, so that the second toner layer may be removed when scratched using a hard object.

2. The document of claim 1, further comprising a barrier layer between the first toner layer and the second toner layer.

3. The document of claim 1, wherein the second toner layer covers only the content to be masked of the first toner layer.

4. The document of claim 2, wherein the barrier layer comprises an ultraviolet coating.

5. The document of claim 4, wherein the second toner layer covers the barrier layer, and the second toner layer covers only the content to be masked of the first toner layer.

6. A scratch-off document comprising:
a base material, wherein the base material comprises a preprinted content to be masked; and
a toner layer removably affixed to the base material, so that the toner layer may be removed when scratched using a hard object.

7. The document of claim 6, wherein the preprinted content to be masked is formed by a xerographic or offset process.

8. The document of claim 6, wherein the preprinted content to be masked is formed by a printing process selected from the group consisting of relief printing, screen printing, intaglio printing, digital-based ink jet printing and laser printing.

9. The document of claim 6, wherein the toner layer only covers the content to be masked.

10. The document of claim 6, wherein the toner layer has a color or pattern that masks the preprinted content to be masked.

11. The document of claim 6, further comprising a barrier layer between the base material and the toner layer, wherein the toner layer is removably affixed to the barrier layer.

12. The document of claim 11, wherein the barrier layer covers only the preprinted content to be masked.

13. The document of claim 11, wherein the barrier layer comprises an ultraviolet coating.

14. The document of claim 11, wherein the toner layer covers the barrier layer, which covers only the preprinted content to be masked.

15. A method of producing a scratch-off document comprising:
providing a base material, wherein the base material comprises content to be masked; and
applying a toner layer that is removably affixed to the base material, so that the second toner layer may be removed when scratched using a hard object.

16. The method of claim 15, wherein the content to be masked is formed using a xerographic printing method.

17. The method of claim 15, wherein the content to be masked is formed using an offset printing method.

18. The method of claim 15, wherein the content to be masked is formed by a printing process selected from the group consisting of relief printing, screen printing, intaglio printing, digital-based ink jet printing, and laser printing.

19. The method of claim 15, wherein the toner layer is applied only over the content to be masked.

20. The method of claim 15, wherein a barrier layer is applied between the base material and the toner layer, and the toner layer is removably affixed to the barrier layer.
